(19) United States
(12) Patent Application Publication
(10) Pub. No.: US 2014/0119277 A1
(43) Pub. Date: May 1, 2014

(54) WIRELESS DEVICE

(71) Applicant: CAMBRIDGE SILICON RADIO LIMITED, Cambridge (GB)

(72) Inventors: Abid ATHANKUTTY, Cambridgeshire (GB); Francoise BANNISTER, Central Bedfordshire (GB); Atul JOSHI, Pune (IN); Mark RISON, Cambridgeshire (GB); Hamid Zare DOUST, Cambridgeshire (GB); Alexander THOUKYDIDES, Cambridge (GB)

(73) Assignee: Cambridge Silicon Radio Limited, Cambridge (GB)

(21) Appl. No.: 13/662,001

(22) Filed: Oct. 26, 2012

(51) Int. Cl. H04W 88/06

(52) U.S. Cl. CPC H04W 88/06
USPC 370/328

(57) ABSTRACT

The present application relates to a wireless device that is able to operate in overlapping first and second wireless networks. The wireless device is configured to adjust the time at which it transmits beacons for the second wireless network so that the time at which beacons are transmitted by the wireless device does not coincide with the time at which beacons for the first wireless network are transmitted.

### TECHNICAL FIELD

The present application relates to a wireless device and to a method for operating a wireless device in multiple wireless networks.

### BACKGROUND TO THE INVENTION

Wireless access points operating under the IEEE 802.11 (Wi-Fi®) family of standards typically transmit a periodic beacon frame signal at predetermined target beacon transmit times (TBTT). The beacon frame contains data such as the SSID (Service Set IDentification), which identifies the wireless network or Basic Service Set (BSS) in which the access point is operating, the channel number of the BSS and security protocols such as WEP (Wired Equivalent Privacy) or WPA (Wi-Fi Protected Access). This beacon frame signal can be used by compatible devices such as laptop, tablet or desktop computers, mobile telephones and the like (referred to as wireless stations) that are within range of the wireless access point to detect the wireless access point, so allowing the devices to join the wireless network in which the wireless access point is operating.

Typically the beacon signal is scheduled to be transmitted by the wireless access point at fixed intervals, such that the time between consecutive beacon signal transmissions is fixed. The interval may be, for example, 100 “time units” (TUs), which equates to 102.4 ms (i.e. each TU is 1.024 ms).

In some circumstances a wireless device may operate in more than one BSS. For example, a wireless enabled device may act both as a station in a first BSS in which a wireless access point is operating and as a Wi-Fi Direct (WFD) group owner (GO) in a second BSS containing the device and other devices in an ad-hoc peer to peer arrangement. In these circumstances, the wireless enabled device must receive beacon signals from the first BSS, but must also transmit beacon signals to maintain the second BSS, which typically operates on a different frequency. The TBTTs of the first and second BSSs may coincide for extended periods in such circumstances. However, the wireless enabled device can typically only operate on one frequency at a time, and thus if the TBTTs of both BSSs coincide, the wireless enabled device will either fail to receive a beacon signal from the first BSS or will fail to transmit a beacon signal for the second BSS. In either case, the performance of the affected BSS will suffer.

### SUMMARY OF INVENTION

The present application relates to a wireless device that is able to operate in overlapping first and second wireless networks. The wireless device is configured to adjust the time at which it transmits beacons for the second wireless network so that the time at which beacons are transmitted by the wireless device does not coincide with the time at which beacons for the first wireless network are transmitted.

According to a first aspect of the invention there is provided a wireless device for use in overlapping first and second wireless networks, the wireless device being configured to transmit a beacon signal for the second wireless network at predetermined intervals, wherein the wireless device is configured to select a time interval between a beacon signal transmission and a subsequent beacon signal transmission such that an intended time at which a beacon signal of the wireless device is to be transmitted generally does not coincide with an intended time at which a beacon signal of the first wireless network is to be transmitted.

The interval between a beacon signal transmission and a subsequent beacon signal transmission may be selected based on a property of the second wireless network.

For example, the property of the second wireless network on which the selection of the interval is based may comprise an identifier of the wireless network.

The interval between the beacon signal transmission and the subsequent beacon signal transmission may be non-uniform.

The wireless device may be configured to detect a beacon signal of the first wireless network and determine, from the detected beacon signal, a time interval between adjacent beacon intervals for the first wireless network, and to select a time interval between beacon signal transmissions for the second wireless network such that an intended time at which a beacon signal of the wireless device is to be transmitted generally does not coincide with an intended time at which a beacon signal of the first wireless network is to be transmitted.

The wireless device may be configured to operate as a wireless station in the first wireless network, and as a group owner in the second wireless network.

According to a second aspect of the invention there is provided a wireless device for use in overlapping first and second wireless networks, the wireless device being configured to transmit a beacon signal for the second wireless network at target transmission times, wherein the wireless device is configured to adjust individually the target transmission time for each beacon signal to be transmitted.

The wireless device may be configured to adjust the target transmission time for each beacon signal by generating an offset and adding the offset so generated to a nominal target transmission time for each beacon signal.

The wireless device may be configured to generate the offset pseudo-randomly.

The wireless device may be configured to generate the offset pseudo-randomly based on a property of the second wireless network.

For example, the property of the second wireless network on which the pseudo-random generation of the offset is based may comprise an identifier of the wireless network.

Preferably the offset is non-negative.

The wireless device may be configured to generate the offset as part of a predetermined sequence of offsets according to a property of the second wireless network.

The property of the second wireless network on which the generation of the predetermined sequence of offsets is based may comprise an identifier of the wireless network.

The wireless device may be configured to operate as a wireless station in the first wireless network, and as a group owner in the second wireless network.

According to third aspect of the invention there is provided a wireless network comprising an access point and a wireless device according to the first aspect or the second aspect.

According to a fourth aspect of the invention there is provided a method for operating a wireless device in overlapping first and second wireless networks, the method comprising transmitting, from the wireless device, a beacon signal for the second wireless network at predetermined intervals, the method further comprising selecting, at the wireless device, a time interval between a beacon signal transmission and a subsequent beacon signal transmission such that an intended time at which a beacon signal of the wireless device is to be transmitted generally does not coincide with an intended time at which a beacon signal of the first wireless network is to be transmitted.

The interval between a beacon signal transmission and a subsequent beacon signal transmission may be selected based on a property of the second wireless network.

For example, the property of the second wireless network on which the selection of the interval is based may comprise an identifier of the wireless network.

The interval between the beacon signal transmission and the subsequent beacon signal transmission may be non-uniform.

The method may further comprise detecting, at the wireless device, a beacon signal of the first wireless network and determining from the detected beacon signal, a time interval between adjacent beacon intervals for the first wireless network, and selecting, at the wireless device, a time interval between beacon signal transmissions for the second wireless network such that an intended time at which a beacon signal of the wireless device is to be transmitted generally does not coincide with an intended time at which a beacon signal of the first wireless network is to be transmitted.

The wireless device may be configured to operate as a wireless station in the first wireless network, and as a group owner in the second wireless network.

According to a fifth aspect of the invention there is provided a method for operating a wireless device in overlapping first and second wireless networks, the method comprising transmitting, at the wireless device, a beacon signal for the second wireless network at target transmission times, wherein the target transmission time for each beacon signal to be transmitted is adjusted individually at the wireless device.

The target transmission time for each beacon signal may be adjusted by generating, at the wireless device, an offset and adding the offset so generated to a nominal target transmission time for each beacon signal.

The offset may be generated pseudo-randomly.

The offset may be generated pseudo-randomly based on a property of the second wireless network.

For example, the property of the second wireless network on which the pseudo-random generation of the offset is based may comprise an identifier of the wireless network.

Preferably the offset is non-negative.

The offset may be generated as part of a predetermined sequence of offsets according to a property of the second wireless network.

For example, the property of the second wireless network on which the generation of the predetermined sequence of offsets is based may comprise an identifier of the wireless network.

The wireless device may be configured to operate as a wireless station in the first wireless network, and as a group owner in the second wireless network.

### BRIEF DESCRIPTION OF THE DRAWINGS

Embodiments of the invention will now be described, strictly by way of example only, with reference to the accompanying drawings, of which

FIG. 1 is a schematic representation of a wireless network architecture;

FIG. 2 is a schematic timing diagram illustrating beacon signal timing in different BSSs;

FIG. 3 is a schematic timing diagram illustrating an alternative beacon timing strategy;

FIG. 4 is a schematic timing diagram illustrating a further alternative beacon timing strategy.

### DESCRIPTION OF THE EMBODIMENTS

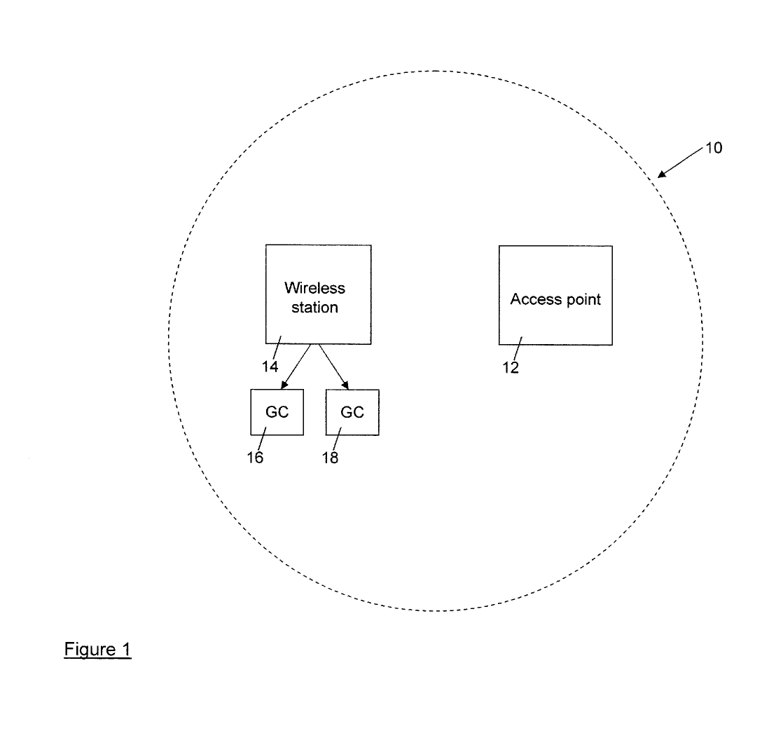

FIG. 1 is a schematic representation of an exemplary wireless network architecture. In the architecture illustrated in FIG. 1 a wireless network 10 is accessed by means of an access point 12. A wireless station 14 such as a laptop or tablet computer, mobile telephone or the like accesses the network 10 via the access point 12. Of course, the network illustrated in FIG. 1 is only an example used for the purpose of describing the invention, and it will be appreciated that the invention is not limited to devices such as wireless access points, laptop or tablet computers, mobile telephones or the like, but is equally applicable to any device that is able to operate in multiple wireless networks. Thus, it will be understood that the term “wireless device” as used in the present specification encompasses devices that act as wireless access points or as wireless stations.

The wireless station 14 also acts as a group owner (GO) for a Wi-Fi direct (WFD) ad-hoc peer-to-peer network containing group clients (GC) 16, 18, which may be, for example, laptop or tablet computers, mobile telephones or the like.

It will be appreciated that the wireless station 14 is part of a first BSS in which the access point 12 is operating. As the wireless station 14 is also acting as a group owner for the ad-hoc network containing the group clients 16, 18, it is also part of a second BSS containing the GCs 16, 18. The first BSS and the second BSS typically operate on different frequencies within the Wi-Fi frequency band.

The access point 12 periodically transmits a beacon frame signal in the first BSS, in accordance with a predetermined schedule which defines target beacon transmit times (TBTTs) and an interval between TBTTs, which is known as a beacon interval. The beacon frame of the first BSS is received by the wireless station 14.

In order to maintain the ad-hoc peer-to-peer network, the wireless station 14 periodically transmits a beacon signal in the second BSS containing the wireless station 14 and the GCs 16, 18 in accordance with a predetermined schedule which defines TBTTs and a beacon interval.

The first BSS containing the access point 12 and the wireless station 14 typically operates on a different frequency to the second BSS containing the wireless station 14 and the GCs 16, 18, and the wireless station 14 is typically only able to operate on only one frequency at a time. In this situation, a problem can arise if the TBTTs of the first BSS coincide with the TBTTs of the second BSS, as the wireless station 14 is not able simultaneously to receive a beacon from the first BSS and transmit a beacon for the second BSS. Thus, in this situation either the performance of the ad-hoc network containing the GCs 16, 18 will be diminished, as the required beacon signal cannot be transmitted at the correct time, causing an increase in power consumption of the GCs, as they will “wake up” to receive beacons that are never transmitted, or the wireless station 14 will not be able to participate in the first BSS, as it cannot receive the beacon signal for the first BSS at the correct time.

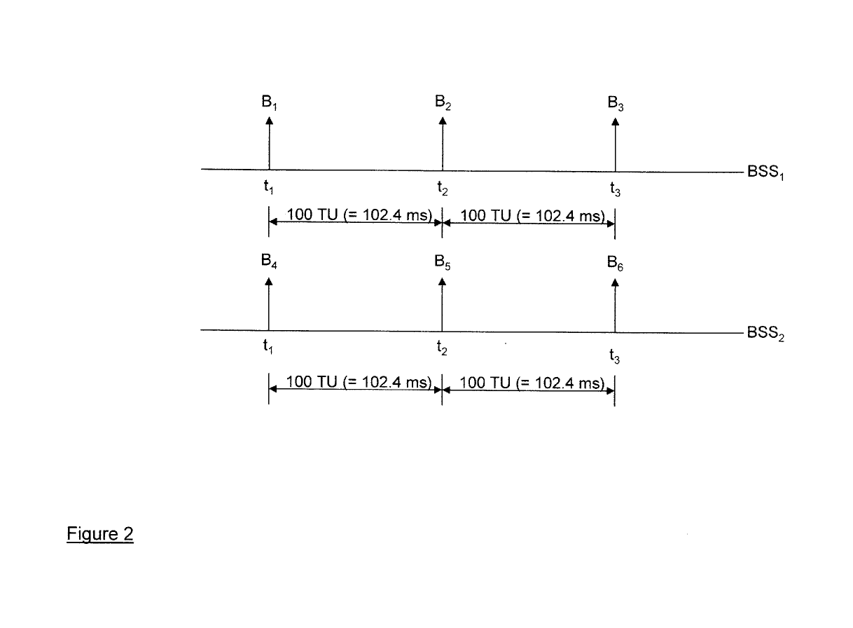

This problem is illustrated in FIG. 2, which is a schematic timing diagram illustrating beacon frame timing for the wireless station 14 shown in FIG. 1, in which the first BSS containing the access point 12 and the wireless station 14 is identified as BSS₁ and the second BSS containing the wireless station 14 and the GCs 16, 18 is identified as BSS₂.

As can be seen from FIG. 2, the access point 12 is scheduled to transmit a first beacon frame B₁ at a target beacon transmit time (TBTT) t₁. A second beacon frame B₂ is transmitted at a TBTT t₂, after a beacon interval of 100 time units (TUs), which interval is equal to 102.4 milliseconds, as is conventional. A third beacon frame B₃ is transmitted at a TBTT t₃, again after a beacon interval of 100 TUs after the transmission of the second beacon frame B₂.

The wireless station 14, operating in BSS₂, also transmits its own beacon frames B₄, B₅, B₆ for BSS₂ at specified TBTTs and with a specified beacon interval, which in the example illustrated in FIG. 2 are the same as those of BSS₁. Therefore the TBTTs for the beacon frames B₄, B₅, B₆ for BSS₂ coincide with the TBTTs t₁, t₂, t₃ for the beacon frames B₁, B₂, B₃ for BSS₁, and a beacon frame collision exists, since the wireless station 14 is unable to receive beacon the frames for BSS₁ and transmit beacon frames for BSS₂ at the same TBTTs. Thus, at each TBTT, either the wireless station 14 will not be able to receive a beacon frame for BSS₁, or will not be able to transmit a beacon frame for BSS₂, which can lead to impaired performance of the affected BSS.

Even if there is initially a time offset between TBTTs of the different BSSs, this problem can still occur, due to clock drift in the access point 12 and in the wireless station 14, which may eventually cause a TBTT for BSS₁ to coincide with a TBTT of BSS₂.

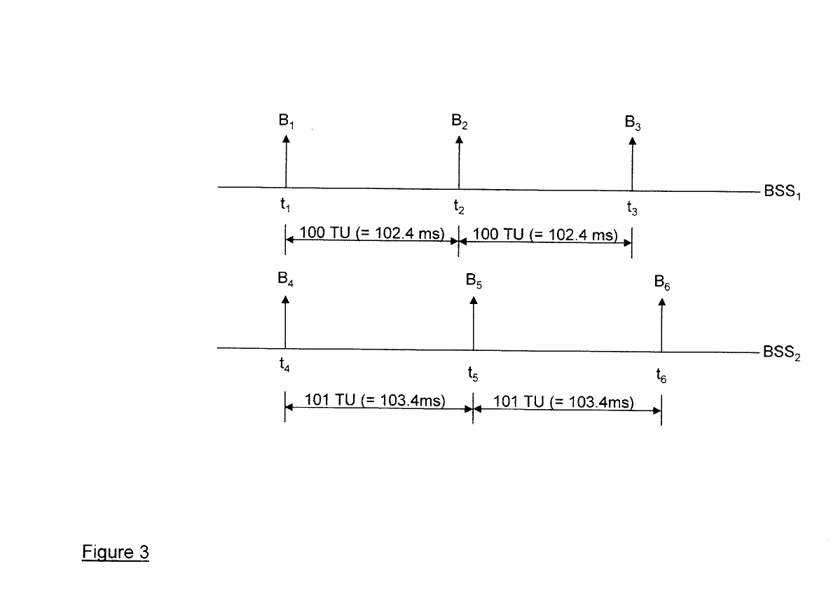

This problem may be addressed by configuring the wireless station 14 to adjust the beacon interval for BSS₂, such that the TBTTs of the BSSs do not coincide with one another. This is illustrated in FIG. 3.

As can be seen, the TBTTs for BSS₁ remain at times t₁, t₂, t₃, and are separated by a constant beacon interval of 100 TUs, whilst the TBTTs for BSS₂ are set to different times t₄, t₅, t₆, and an adjusted beacon interval, which is 101 TUs in this example, is used.

Thus, the beacon frames B₅ and B₆ of BSS₂ do not collide with the beacon frames B₂ and B₃ of BSS₁. This approach mitigates the problem of beacon collision somewhat, but it will be appreciated that for overlapping BSSs that persist for a sufficiently long period of time there will still be occasions when the TBTTs for the different BSSs coincide or nearly coincide.

The selection of the adjusted beacon interval for the second BSS may be based on a unique property or characteristic of the first BSS. For example, the BSSID (Basic Service Set IDentification) of the second BSS may be used to select one of a plurality of different fixed beacon intervals that do not conflict with the beacon interval of the first BSS, whose beacon interval remains unchanged.

This approach can be successfully used in environments where the wireless station 14 is required to operate in only a small number of BSSs. However, the number of available different beacon intervals is limited. Moreover, a beacon interval of 100 milliseconds is desirable, as it provides a balance between power consumption and latency, since a BSS with a beacon interval of 100 milliseconds generally requires devices operating in the BSS to “wake up” for a short period every 100 milliseconds or so to receive beacon signals. If the beacon interval is set to a period significantly shorter than 100 milliseconds, devices will be unable to detect the beacon frame signal, since they will only “wake up” after the beacon signal has been transmitted. Conversely, if the beacon interval is set to be too long, the devices will miss the beacon frame signal as by the time it is transmitted the client devices will have reverted to sleep mode, unless any change to the expected beacon interval of 100 milliseconds is also advertised in a beacon previously received by the client devices. Thus, demand for beacon intervals close to 100 ms in such a system will be high.

As an alternative or additional measure, the wireless station 14 may be configured to select a beacon interval that is not in use by any BSS in which the wireless station is active. As each BSS in which the wireless station 14 is active periodically transmits a beacon frame signal, the wireless station 14 is able to detect beacon frame signals for each BSS, and from these detected beacon frames determine the beacon intervals used by each of those BSSs. The wireless station 14 may then select a beacon interval that is known not to be in use by a BSS in which the wireless station 14 is active.

The wireless station 14 may also be configured to select a beacon interval that is not used by any BSS in which the wireless station 14 is likely to become active. Typically the wireless station 14 will have a memory in which the BSSIDs of BSSs in which it has recently been active, or in which it is regularly active, are stored. Again, as the wireless station 14 will have received periodic beacon signals from these recent and regular BSSs the beacon intervals of the recent BSSs are known to or can be determined by the wireless station 14. Thus, the wireless station 14 is able to select a beacon interval that is not in use in any BSS in which it is currently active, or in which it is likely to be active in the future.

One disadvantage this approach is that it is not always possible accurately to predict those BSSs in which the wireless station 14 will be active in the future. Moreover, the beacon intervals of the recent or regular BSSs may change, and so it is not possible to guarantee that the selected beacon interval will not collide with that of a recent or regular BSS. Additionally, the wireless station 14 may be unable to detect beacon signals from overlapping BSSs or from a mobile access point that is out of range but that later comes into range. Thus, a risk of collision between beacon intervals remains.

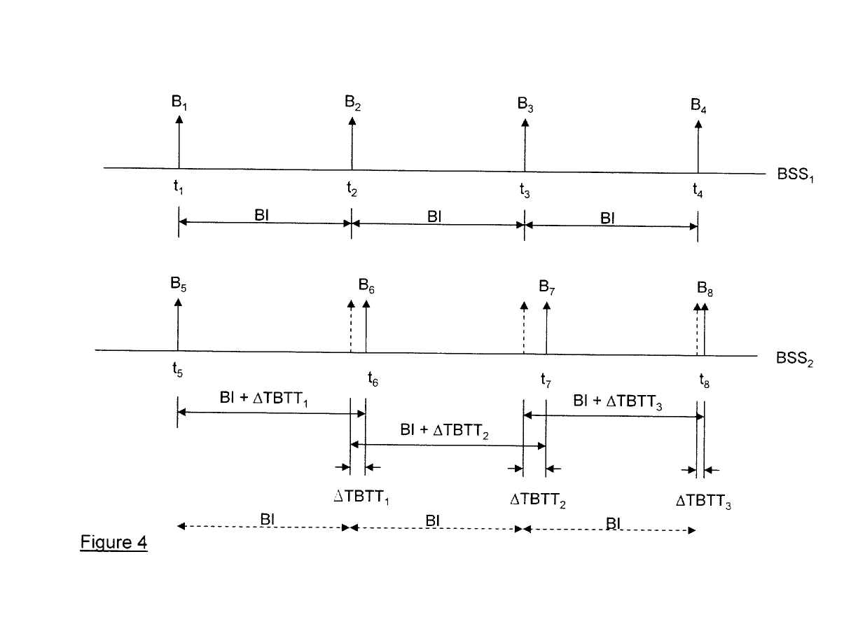

An alternative approach is to configure the wireless station 14 to adjust the TBTT for each beacon signal it transmits individually, such that the beacon interval between adjacent transmitted beacon frames is non-uniform. This reduces the probability that beacon signals transmitted by the wireless station 14 will collide with beacon signals of other BSSs. One way of doing this is to generate a time offset to be added to the TBTT each time a beacon frame is transmitted by the wireless station 14, as will now be described, with reference to FIG. 4.

In FIG. 4 the beacon intervals for BSS₁ are shown for reference purposes. The TBTTs for beacons B₁, B₂, B₃, B₄ of BSS₁ are at times t₁, t₂, t₃, t₄, and are separated by a constant beacon interval, such as 100 TUs for example. In contrast, the wireless station 14 is configured to set the TBTTs for the beacons B₅, B₆, B₇, B₈ of BSS₂ to times t₅, t₆, t₇, t₈, with the actual beacon interval between each beacon B₅, B₆, B₇, B₈ and its adjacent beacon being non-uniform.

The wireless station 14 is pre-configured with a nominal beacon interval BI, which may be, for example, 100 TUs. However, the actual interval between any two transmitted beacons differs from the nominal beacon interval BI, as a result of the pseudo-random selection of a TBTT offset for each TBTT. For example, the beacon interval between beacons B₅ and B₆ is (BI+ΔTBTT₁), as a result of a TBTT offset ΔTBTT₁, whilst the beacon interval between beacons B₆ and B₇ is (BI+ΔTBTT₂), as a result of a TBTT offset ΔTBTT₂ and the beacon interval between beacons B₇ and B₈ is (BI+ΔTBTT₃) as a result of a TBTT offset ΔTBTT₃.

The value of each TBTT offset ΔTBTT may be calculated or determined by the wireless station 14 based on a unique property of the BSS supported by the wireless station 14, such as the BSSID. For example, the whole or part of the BSSID may be input as a seed value into an algorithm that generates a pseudo-random sequence of numbers within upper and lower threshold values. The first number in this pseudo-random sequence may be selected as the first TBTT offset ΔTBTT₁, with the second number being selected as the second TBTT offset ΔTBTT₂, the third number in the pseudo-random sequence being selected as the third TBTT offset ΔTBTT₃ and so on. In this way, the beacon interval between adjacent transmitted beacon frames is non-uniform, which reduces the probability of repeated collisions between the beacons of BSS₂ transmitted by the wireless station 14 and beacons of another overlapping BSS.

In the example illustrated in FIG. 4 the TBTT offsets ΔTBTT₁, ΔTBTT₂ and ΔTBTT₃ are shown as positive offsets which increase the actual beacon interval. It is possible for the TBTT offset value ΔTBTT to be negative, such that the beacon interval is reduced. However, for backward compatibility with existing devices it is advantageous for the TBTT offset value ΔTBTT to be positive such that the beacon interval is increased, to ensure that such existing devices do not wake up too late to receive the transmitted beacon frame signal. The lower threshold value of the algorithm that generates the TBTT offset values should therefore be non-negative. Similarly, the upper threshold value of the algorithm that generates the TBTT offset values should be small, to reduce the likelihood that such existing devices will wake up and return to sleep mode before a beacon signal is transmitted according to the modified TBTT derived by adding the generated TBTT value ΔTBTT to the ideal TBTT.

As an alternative to generating the value of each TBTT value ΔTBTT using an algorithm that generates a pseudo-random sequence of numbers, the wireless station 14 may instead use an algorithm that generates a different predetermined sequence of TBTT offset values ΔTBTT according to an input such as the BSSID of the BSS that is supported by the wireless station 14. Thus, for a first input value the algorithm may generate a first predetermined sequence of TBTT offset values ΔTBTT {1, 0.5, 1.5, 1, 2 . . . }, whereas for a second, different input value the algorithm may generate a second predetermined sequence of TBTT offset values ΔTBTT {2, 1.5, 0, 1, 0 . . . }. In this way, different BSSs (supported by different wireless stations 14) will use different sequences of TBTT offset values ΔTBTT, thus achieving the aim of reducing the probability of repeated collisions between beacon signals of different BSSs. Additionally, by making the algorithm used by the wireless station 14 available to the GCs 16, 18, individual GCs 16, 18 can use the algorithm to determine the sequence of TBTT offset values ΔTBTT for the particular BSS in which they are participating, and can schedule their wake-up times such that they will be awake to receive beacon signals from the BSS at the modified beacon intervals, but not earlier than the modified beacon intervals, which would waste power.

As will be appreciated, the techniques described above with reference to FIGS. 3 and 4 of the accompanying drawings address the problem of repeated beacon collisions in overlapping BSSs. Beacon frames transmitted by a wireless station 14 implementing one or more of the described techniques are less likely to collide repeatedly with beacon frames transmitted by access points of BSSs that overlap with the BSS supported by the wireless station 14 for any significant period of time. Thus, the wireless station 14 is able to support an ad-hoc network containing group clients whilst also operating itself in an overlapping BSS supported by an access point 12. Of course, it will be appreciated that the same effect could be achieved if the access point 12 implemented one or more of the techniques described above and the wireless station 14 did not, since there would be no overlap between beacons of the BSS supported by the access point 12 and beacons of the BSS supported by the wireless station 14.

Thus, although the invention has been described with reference to the exemplary network architecture illustrated in FIG. 1, it will be appreciated that the invention is equally suited to other network architectures. Moreover, although the invention has been described in terms of the wireless station 14, it will be appreciated that the invention is equally applicable to any wireless device that operates in overlapping BSSs. For example, the invention could be used in a situation where a wireless device such as a mobile telephone or the like acting as a wireless station is present in overlapping wireless networks supported by first and second wireless access points and is not itself transmitting beacon signals. If the first and second wireless access points is unable to detect each other (i.e. a hidden node situation), they may both transmit beacon signals at the same time, which may cause difficulties for the wireless station in participating in both of the wireless networks, since it is unlikely to be able to receive beacon signals from both access points simultaneously. In this situation, the wireless station may notify one or both of the access points of the conflict, to cause one or both of the access points to adjust its beacon transmission timings using one of the techniques described above, thereby reducing the probability of repeated collisions between the beacons transmitted by the first and second wireless access points. Alternatively, one or both of the access points may already be implementing one of the techniques described above, in which case the probability of repeated collisions between beacons transmitted by the first and second wireless access points is reduced, so the wireless device benefits from the advantages associated with the invention.

1. A wireless device for use in overlapping first and second wireless networks, the wireless device being configured to transmit a beacon signal for the second wireless network at predetermined intervals, wherein the wireless device is configured to select a time interval between a beacon signal transmission and a subsequent beacon signal transmission such that an intended time at which a beacon signal of the wireless device is to be transmitted generally does not coincide with an intended time at which a beacon signal of the first wireless network is to be transmitted.

2. A wireless device according to claim 1 wherein the interval between a beacon signal transmission and a subsequent beacon signal transmission is selected based on a property of the second wireless network.

3. A wireless device according to claim 2 wherein the property of the second wireless network on which the selection of the interval is based comprises an identifier of the wireless network.

4. A wireless device according to claim 1 wherein the interval between the beacon signal transmission and the subsequent beacon signal transmission is non-uniform.

5. A wireless device according to claim 1 wherein the wireless device is configured to detect a beacon signal of the first wireless network and determine, from the detected beacon signal, a time interval between adjacent beacon intervals for the first wireless network, and to select a time interval between beacon signal transmissions for the second wireless network such that an intended time at which a beacon signal of the wireless device is to be transmitted generally does not coincide with an intended time at which a beacon signal of the first wireless network is to be transmitted.

6. A wireless device according to claim 1 wherein the wireless device is configured to operate as a wireless station in the first wireless network and as a group owner in the second wireless network.

7. A wireless device for use in overlapping first and second wireless networks, the wireless device being configured to transmit a beacon signal for the second wireless network at target transmission times, wherein the wireless device is configured to adjust individually the target transmission time for each beacon signal to be transmitted.

8. A wireless device according to claim 7 wherein the wireless device is configured to adjust the target transmission time for each beacon signal by generating an offset and adding the offset so generated to a nominal target transmission time for each beacon signal.

9. A wireless device according to claim 8 wherein the wireless device is configured to generate the offset pseudo-randomly.

10. A wireless device according to claim 9 wherein the wireless device is configured to generate the offset pseudo-randomly based on a property of the second wireless network.

11. A wireless device according to claim 10 wherein the property of the second wireless network on which the pseudo-random generation of the offset is based comprises an identifier of the wireless network.

12. A wireless device according to claim 7 wherein the offset is non-negative.

13. A wireless device according to claim 7 wherein the wireless device is configured to generate the offset as part of a predetermined sequence of offsets according to a property of the second wireless network.

14. A wireless device according to claim 13 wherein the property of the second wireless network on which the generation of the predetermined sequence of offsets is based comprises an identifier of the wireless network.

15. A wireless device according to claim 7 wherein the wireless is configured to operate as a wireless station in the first wireless network and as a group owner in the second wireless network.

16. A wireless network comprising an access point and a wireless device according to claim 1.

17. A wireless network comprising an access point and a wireless device according to claim 7.

18. A method for operating a wireless device in overlapping first and second wireless networks, the method comprising transmitting, from the wireless device, a beacon signal for the second wireless network at predetermined intervals, the method further comprising selecting, at the wireless device, a time interval between a beacon signal transmission and a subsequent beacon signal transmission such that an intended time at which a beacon signal of the wireless device is to be transmitted generally does not coincide with an intended time at which a beacon signal of the first wireless network is to be transmitted.

19. A method according to claim 18 wherein the interval between a beacon signal transmission and a subsequent beacon signal transmission is selected based on a property of the second wireless network.

20. A method according to claim 19 wherein the property of the second wireless network on which the selection of the interval is based comprises an identifier of the wireless network.

21. A method according to claim 18 wherein the interval between the beacon signal transmission and the subsequent beacon signal transmission is non-uniform.

22. A method according to claim 18 further comprising detecting, at the wireless device, a beacon signal of the first wireless network and determining from the detected beacon signal, a time interval between adjacent beacon intervals for the first wireless network, and selecting, at the wireless device, a time interval between beacon signal transmissions for the second wireless network such that an intended time at which a beacon signal of the wireless device is to be transmitted generally does not coincide with an intended time at which a beacon signal of the first wireless network is to be transmitted.

23. A method according to claim 16 wherein the wireless device is configured to operate as a wireless station in the first wireless network and as a group owner in the second wireless network.

24. A method for operating a wireless device in overlapping first and second wireless networks, the method comprising transmitting, at the wireless device, a beacon signal for the second wireless network at target transmission times, wherein the target transmission time for each beacon signal to be transmitted is adjusted individually at the wireless device.

25. A method according to claim 24 wherein the target transmission time for each beacon signal is adjusted by generating, at the wireless device, an offset and adding the offset so generated to a nominal target transmission time for each beacon signal.

26. A method according to claim 25 wherein the offset is generated pseudo-randomly.

27. A method according to claim 26 wherein the offset is generated pseudo-randomly based on a property of the second wireless network.

28. A method according to claim 27 wherein the property of the second wireless network on which the pseudo-random generation of the offset is based comprises an identifier of the wireless network.

29. A method according to claim 25 wherein the offset is non-negative.

30. A method according to claim 25 wherein the offset is generated as part of a predetermined sequence of offsets according to a property of the second wireless network.

31. A method according to claim 30 wherein the property of the second wireless network on which the generation of the predetermined sequence of offsets is based comprises an identifier of the wireless network.

32. A method according to claim 24 wherein the wireless device is configured to operate as a wireless station in the first wireless network and as a group owner in the second wireless network.
